(19) United States
(12) Patent Application Publication
(10) Pub. No.: US 2018/0367353 A1
(43) Pub. Date: Dec. 20, 2018

(54) TRANSMIT DIVERSITY FROM ORTHOGONAL DESIGN FOR FBMC/OQAM

(71) Applicant: NTT DOCOMO, INC., Tokyo (JP)

(72) Inventors: Petra Weitkemper, Munich (DE); Katsutoshi Kusume, Munich (DE); Jamal Bazzi, Munich (DE); Mikio Iwamura, Munich (DE)

(73) Assignee: NTT DOCOMO, INC., Tokyo (JP)

(21) Appl. No.: 15/562,989

(22) PCT Filed: Apr. 1, 2016
(86) PCT No.: PCT/EP2016/057240

§ 371 Date: Sep. 29, 2017

(30) Foreign Application Priority Data
Apr. 1, 2015 (EP) 15162248.7

(51) Int. Cl. H04L 27/26; H04L 1/06

(52) U.S. Cl. CPC H04L 27/264; H04L 1/0668; H04L 27/2698

(57) ABSTRACT

How to apply an Alamouti like space-time coding (or transmit diversity) to a Filter Bank Multicarrier (FBMC) transmission using Offset QAM (OQAM). In FBMC, due to the orthogonality in the real domain only, an intrinsic interference results thereof for the imaginary component. Simply adapting the Alamouti scheme to FBMC OQAM is not obvious since the intrinsic interference terms are not equivalent at each antenna since it depends on the surrounding symbols. The application proposes to choose contiguous precoding symbols such that a virtual PAM Alamouti scheme is achieved. Code rates of 1/2 or 2/3 are achieved depending on the number of precoding symbols needed per antenna.

### FIELD OF THE INVENTION

The present technology relates to a method and apparatus for transmitting a multicarrier signal, wherein said signal is of the offset quadrature amplitude modulation (OQAM) type comprising symbols in the time-frequency space, wherein the symbols include a data containing symbol and a precoding symbol.

### BACKGROUND OF THE INVENTION

Transmit diversity is considered to be important since it can be applied at transmitter side to improve the reliability of communication link even if channel state information is not available at the transmitter. That includes high speed mobility scenarios where feedback information from receiver to transmitter becomes quickly obsolete and also broadcast scenarios.

Alamouti code, which is described in S. M. Alamouti: “A simple transmit diversity technique for wireless communications”, IEEE Journal on Select Areas in Communications, vol. 16, no. 8, October 1998, is a popular transmit diversity scheme from orthogonal design for two transmit antennas since it has the following desired properties of.
1. Full diversity
2. Full rate (no rate loss)
3. Simple linear receiver, i.e. the processing required at the receiver scales linearly with the number of transmit antennas.

Alamouti code has been widely adopted, e.g. for LTE OFDM systems.

However, the direct application of the Alamouti scheme for FBMC/OQAM is not possible. So far, considerable amount of efforts have been spent by many industries and universities to find competitive solution for transmit diversity with FBMC/OQAM, but all the state-of-the-art solutions have some drawbacks as explained later.

Before explaining the problem of achieving transmit diversity for FBMC/OQAM, the Alamouti transmission scheme as applied in LTE should be reviewed as illustrated in FIG. 2.

FIG. 2 shows a transmission scheme based on OFDM, wherein the complex QAM symbols s₁ and s₂ are transmitted from the first transmit antenna Tx1 using the two resources (m₀,n₀) and (m₀+1,n₀) where m₀ and n₀ denote subcarrier and time indices, respectively. From the second transmit antenna Tx2 the complex conjugate versions of these QAM symbols are transmitted with or without taking its minus by using the same two resources, but now the used resources for s₁ and s₂ are exchanged. If it is assumed that the complex valued channel frequency responses on subcarriers m₀ and m₀+1 of symbol n₀ are quasi equivalent, denoted as H⁽¹⁾ and H⁽²⁾ for transmit antennas Tx1 and Tx2, respectively, one can write the received signals for the subcarriers m₀ and m₀+1 as shown in equations (1) and (2):

yₘ_{₀}_{,n}_{₀}=H⁽¹⁾s₁−H⁽²⁾s*₂+ηₘ_{₀}_{,n}_{₀} (1)

yₘ_{₀}_{+1,n}_{₀}=H⁽¹⁾s₂+H⁽²⁾s*₁+ηₘ_{₀}_{+1,n}_{₀} (2)

where ηₘ_{₀}_{,n}_{₀} is an AWGN. With some arrangement of these receive signals, the following linear equation system is obtained:

$$[ \begin{matrix}{y}_{{m}_{0} , {n}_{0}} \\ {y}_{{m}_{0} + 1 , {n}_{0}}^{*}\end{matrix} ] = [ \begin{matrix}{H}^{( 1 )} & - {H}^{( 2 )} \\ {H}^{{( 2 )}^{*}} & {H}^{{( 1 )}^{*}}\end{matrix} ] [ \begin{matrix}{s}_{1} \\ {s}_{2}^{*}\end{matrix} ] + [ \begin{matrix}{η}_{{m}_{0} , {n}_{0}} \\ {η}_{{m}_{0} + 1 , {n}_{0}}^{*}\end{matrix} ] \to y = Hs + η \qquad ( 3 )$$

Then, at the receiver the following linear processing is performed:

$$= \frac{1}{{\vert {H}^{( 1 )} \vert}^{2} + {\vert {H}^{( 2 )} \vert}^{2}} {H}^{H} y = [ \begin{matrix}{s}_{1} \\ {s}_{2}^{*}\end{matrix} ] + \frac{1}{{\vert {H}^{( 1 )} \vert}^{2} + {\vert {H}^{( 2 )} \vert}^{2}} {H}^{H} η . \qquad ( 4 )$$

The diversity order of 2 is achieved assuming that the channel response from the transmit antennas Tx1 and Tx2 are independent.

To summarize, the main idea of Alamouti coding is that it is an orthogonal design since only linear combination is needed and it incurs no rate loss because two resources are utilized to deliver two data symbols.

Now, fundamental properties of FBMC/OQAM that are essential for understanding why the Alamouti scheme cannot be directly applied to FBMC/OQAM will be reviewed on the basis of FIG. 3. In the single antenna, single input, single output (SISO) system shown in FIG. 3, a real-valued pulse amplitude modulation (PAM) signal aₘ_{₀}_{,n}_{₀} is transmitted using the resource (m₀,n₀).

The respective baseband equivalent receive signal may be written as

$$\begin{matrix}{y}_{{m}_{0} , {n}_{0}} = {H}_{{m}_{0} , {n}_{0}} ( {a}_{{m}_{0} , {n}_{0}} + j {I}_{{m}_{0} , {n}_{0}} ) + {η}_{{m}_{0} , {n}_{0}} \\ where & ( 5 ) \\ {I}_{{m}_{0} , {n}_{0}} = {\sum }_{{( p , q ) \neq ( 0 , 0 )}_{p , q ∈ \{ - 1 , 0 , + 1 \}}} {a}_{{m}_{0} + p , {n}_{0} + q} {〈 g 〉}_{{m}_{0} + p , {n}_{0} + q} & ( 6 )\end{matrix}$$

is the so called Intrinsic interference coming from data symbols on neighbor subcarriers and symbols. The coefficients [symbol] g [symbol] ₘ_{₀}_{+p,n}_{₀}_{+q} are called ambiguity function that captures the characteristic of the used prototype filter. Here, it is assumed that a good localized filter is used such that the intrinsic Interference is caused only by the immediate neighbor resources, but in general other resources that are located farer apart could also contribute to form the intrinsic interference.

It can be seen that the subcarrier signal is not orthogonal in the complex domain. It is, however, possible to restore the orthogonality in the real domain by channel equalization and taking its real part as

$${\hat{a}}_{{m}_{0} , {n}_{0}} = Re \{ \frac{{y}_{{m}_{0} , {n}_{0}}}{{H}_{{m}_{0} , {n}_{0}}} \} \approx {a}_{{m}_{0} , {n}_{0}} + {η}_{{m}_{0} , {n}_{0}}^{′} \qquad ( 7 )$$

As it can be seen next, there is the consequence on the transmit diversity from the fact that FBMC/OQAM loses the complex orthogonality.

For transmit diversity for FBMC/OQAM, the system model shown in FIG. 4 is considered.

In the scenario shown in FIG. 4, two real-valued PAM signals a₁ and a₂ are transmitted using the two resources (m₀,n₀) and (m₀+1,n₀) from the transmit antenna Tx1. From transmit antenna Tx2, these PAM symbols are transmitted with and respectively without taking its minus by using the same two resources but now the used resources for a₁ and a₂ are exchanged as can be seen in FIG. 4. With the same assumptions on H⁽¹⁾ and H⁽²) from transmit antennas Tx1 and Tx2, the receive signals for the subcarriers m₀ and m₀+1 read as

$$\begin{matrix}{y}_{{m}_{0} , {n}_{0}} = {H}^{( 1 )} \underbrace{( {a}_{1} + j {I}_{{m}_{0} , {n}_{0}}^{( 1 )} )}_{{=}^{Δ} {s}_{1}} - {H}^{( 2 )} \underbrace{( {a}_{2} - j {I}_{{m}_{0} , {n}_{0}}^{( 2 )} )}_{\neq {s}_{2}^{*}} + {η}_{{m}_{0} , {n}_{0}} = {H}^{( 1 )} {s}_{1} - {H}^{( 2 )} ( {s}_{2}^{*} + j {I}_{1} ) + {η}_{{m}_{0} , {n}_{0}} & ( 8 ) \\ {y}_{{m}_{0} + 1 , {n}_{0}} = {H}^{( 1 )} \underbrace{( {a}_{2} + j {I}_{{m}_{0} + 1 , {n}_{0}}^{( 1 )} )}_{{=}^{Δ} {s}_{2}} + {H}^{( 2 )} \underbrace{( {a}_{1} + {jI}_{{m}_{0} + 1 , {n}_{0}}^{( 2 )} )}_{\neq {s}_{1}^{*}} + {η}_{{m}_{0} + 1 , {n}_{0}} = {H}^{( 1 )} {s}_{2} + {H}^{( 2 )} ( {s}_{1}^{*} + j {I}_{2} ) + {η}_{{m}_{0} + 1 , {n}_{0}} & ( 9 )\end{matrix}$$

where the complex valued “virtual symbols” s₁ and s₂ are defined as the real-valued desired signal plus intrinsic interference.

In an attempt to implement the Alamouti scheme, one may introduce the following:

I₁≙Iₘ_{₀}_{+1,n}_{₀}⁽¹⁾−Iₘ_{₀}_{,n}_{₀}⁽²⁾ (10)

I₂≙Iₘ_{₀}_{,n}_{₀}⁽¹⁾+Iₘ_{₀}_{+1,n}_{₀}⁽²⁾ (11)

With some arrangement of these received signals, the following linear equation system is obtained in a similar way as the Alamouti scheme for OFDM as explained above:

$$[ \begin{matrix}{y}_{{m}_{0} , {n}_{0}} \\ {y}_{{m}_{0} + 1 , {n}_{0}}^{*}\end{matrix} ] = \underbrace{[ \begin{matrix}{H}^{( 1 )} & - {H}^{( 2 )} \\ {H}^{{( 2 )}^{*}} & {H}^{{( 1 )}^{*}}\end{matrix} ]}_{Orthogonal design} [ \begin{matrix}{s}_{1} \\ {s}_{2}^{*}\end{matrix} ] + j \underbrace{[ \begin{matrix}- {H}^{( 2 )} & {I}_{1} \\ {H}^{{( 2 )}^{*}} & {I}_{2}\end{matrix} ]}_{Orthogonality is lost} + [ \begin{matrix}{η}_{{m}_{0} , {n}_{0}} \\ {η}_{{m}_{0} + 1 , {n}_{0}}^{*}\end{matrix} ] \qquad ( 12 )$$

It can however be observed that the orthogonality is lost due to the second term on the right hand side of the equation system. The main reason for this is that the intrinsic interferences for the transmitted signals from different antennas are not equivalent since the surrounding data of each time-frequency resource grid are different due to the random nature of data signals. This explains the problem that the transmit diversity from the orthogonal design following the Alamouti coding scheme cannot be applied to FBMC/OQAM in a straightforward manner.

Several attempts to address this problem of non-orthogonality can be found in the literature and will be discussed in the following:

In M. Bellanger, “Transmit diversity in multicarrier transmission using OQAM modulation,” in Proc. The 3rd Int. Symposium on Wireless Pervasive Computing (ISWPC'08), pp. 727-730, May 2008, the author proposes a simple delay diversity where no effort is made to realize orthogonality. Although this approach does not have any rate loss, due to its non-orthogonality, it requires very complex maximum likelihood receiver and it does not achieve full diversity.

The authors in H. Lin, C. Lele, P. Siohan, “A pseudo Alamouti transceiver design for OFDM/OQAM modulation with cyclic prefix,” in Proc. SPAWC, 2009 propose to introduce a cyclic prefix which is common for OFDM, but not for FBMC/OQAM. Because of the cyclic prefix, the orthogonality can be realized, but it results in a rate loss.

Another approach, presented in by C. Lele, P. Siohan, R. Legouable, “The Alamouti scheme with CDMA-OFDM/OQAM”, EURASIP Journal on Advances in Signal Processing, 2010, suggests the spreading and dispreading using Walsh-Hadamard codes for nullifying Intrinsic Interferences. Thanks to spreading/dispreading, orthogonality can be achieved, but a rate loss results.

In M. Renfors, T. Ihalainen, T. H. Stitz, “A Block-Alamouti Scheme for Filter Bank Based Multicarrier Transmission,” Proceedings of the European Wireless Conference 2010, a block Alamouti scheme using some zero symbols is introduced based on orthogonal design. The idea is to apply the Alamouti scheme to two areas of symbols instead of two symbols such that the Intrinsic interference caused from 2 different transmit antennas are equivalent. Some zero symbols are added around the areas to avoid “edge effect”. The zero symbols lead to rate loss. Besides, the applicability of the scheme may be limited since channel has to be constant over blocks that may not hold for many propagation scenarios, e.g. for mobile scenarios.

To summarize, there has not been any solution in the literature that can realize the orthogonal design without rate loss.

### SUMMARY OF THE INVENTION

According to one embodiment, there is provided a method for transmitting a multicarrier signal, wherein said signal is of the offset quadrature amplitude modulation, OQAM, type comprising symbols in the time-frequency space, wherein the symbols include one of a data containing symbol and a precoding symbol, wherein the method is characterized in that the precoding symbol is selected such that intrinsic interference at the data containing symbol, when received by a receiver, is forced to a value of an applied space-time or space-frequency code.

This has the effect and advantage that a real-valued symbol can be transmitted to the receiver without the intrinsic interference (orthogonal design) or with the reduced amount of intrinsic interference (quasi-orthogonal design).

In one embodiment, said symbols are formed by modulating a real-valued symbol and the intrinsic interference corresponds to the imaginary part of the demodulated signal at the receiver, or said symbols are formed by modulating an imaginary valued symbol and the intrinsic interference corresponds to the real-valued part of the demodulated signal at the receiver.

In one embodiment, the selecting of the precoding symbol is performed by forcing the Intrinsic interference such that an orthogonal space-time or space-frequency code is formed.

Thereby, orthogonality means that the intrinsic interference at the data containing symbol, when received by the receiver, is forced to zero when applying the space-time or space-frequency code.

This has the advantage that the transmission scheme is orthogonal and thus demodulation of the signals in case of transmit diversity may have only linear complexity in the number of antennas. This has the further effect and advantage that orthogonality of the coding is achieved so that transmit diversity according to the scheme of Alamouti may be applied.

In one embodiment, the selecting of the precoding symbol is performed by forcing the intrinsic interference, when received by the receiver, to be zero.

This has the effect and advantage that the intrinsic interference need not be considered when demodulating a transmitted symbol from a subcarrier used for data transmission.

In one embodiment all resources are taken into account for computing the intrinsic interference and the precoding symbol is designed to null the intrinsic interference that results in the orthogonal design since no intrinsic interference may be observed at the receiver.

This has the advantage that the performance does not degrade and the receiver does not need to perform any further processing to cancel the remaining intrinsic Interference.

According to one embodiment there are transmitted real-valued PAM signals a₁ and a₂ are transmitted using the two resources (m₀,n₀) and (m₀+1,n₀) from the transmit antenna Tx1. From transmit antenna Tx2, these PAM symbols are transmitted with and respectively without taking its minus by using the same two resources but now the used resources for a₁ and a₂ are exchanged so that the receive signals for the subcarriers m₀ and m₀+1 read as

$${y}_{{m}_{0} , {n}_{0}} = {H}^{( 1 )} ( {a}_{1} + j \overbrace{{I}_{{m}_{0} , {n}_{0}}^{( 1 )}}^{\to 0} ) - {H}^{( 2 )} ( {a}_{2} - j \overbrace{{I}_{{m}_{0} , {n}_{0}}^{( 2 )}}^{\to 0} ) + {η}_{{m}_{0} , {n}_{0}} \\ {y}_{{m}_{0} + 1 , {n}_{0}} = {H}^{( 1 )} ( {a}_{2} + j \overbrace{{I}_{{m}_{0 + 1} , {n}_{0}}^{( 1 )}}^{\to 0} ) + {H}^{( 2 )} ( {a}_{1} + j \overbrace{{I}_{{m}_{0} + 1 , {n}_{0}}^{( 2 )}}^{\to 0} ) + {η}_{{m}_{0} + 1 , {n}_{0}} \qquad ( 13 )$$

wherein yₘ_{₀}_{,n}_{₀} is the received signal at the resource at (m₀,n₀) in the time-frequency domain, ηₘ_{₀}_{,n}_{₀} is AWGN and Iₘ_{₀}_{,n}_{₀}⁽¹⁾ and Iₘ_{₀}_{,n}_{₀}⁽²⁾ being the intrinsic interference from the first and the second antenna at resource (m₀,n₀) respectively, and wherein precoding symbols x₁,x₂,x₃,x₄ are chosen to cancel (zero) the intrinsic interference individually for each antenna by the symbols x₁,x₂ being chosen to cancel the intrinsic interferences Iₘ_{₀}_{,n}_{₀}⁽¹⁾ Iₘ_{₀}_{+1,n}_{₀}⁽¹⁾ of the first antenna and by x₃,x₄ being chosen to cancel the intrinsic interferences Iₘ_{₀}_{,n}_{₀}⁽²⁾ Iₘ_{₀}_{+1,n}_{₀}⁽²⁾ of the second antenna.

This embodiment leads to an orthogonal design and achieves a code rate of 1/2, i.e. the transmission of one data symbol requires two time units since one precoding symbol is transmitted per data symbol.

According to one embodiment there are transmitted real-valued PAM symbols a₁ and a₂ are transmitted using the two resources (m₀,n₀) and (m₀+1,n₀) from the transmit antenna Tx1, wherein from transmit antenna Tx2, these PAM symbols a₁ and a₂ are transmitted with and respectively without taking its minus by using the same two resources but now the used resources for a₁ and a₂ are exchanged so that the receive signals for the subcarriers m₀ and m₀+1 read as

$$\begin{matrix}\begin{matrix}{y}_{{m}_{0} , {n}_{0}} = {H}^{( 1 )} \overbrace{( {a}_{1} + j {I}_{{m}_{0} , {n}_{0}}^{( 1 )} )}^{{=}^{Δ} {s}_{1}} - {H}^{( 2 )} \overbrace{( {a}_{2} - j {I}_{{m}_{0} , {n}_{0}}^{( 2 )} )}^{\neq {s}_{2}^{*}} + {η}_{{m}_{0} , {n}_{0}} \\ = {H}^{( 1 )} {s}_{1} - {H}^{( 2 )} ( {s}_{2}^{*} \underbrace{+ j {I}_{1}}_{\to 0} ) + {η}_{{m}_{0} , {n}_{0}}\end{matrix} \\ \begin{matrix}{y}_{{m}_{0} + 1 , {n}_{0}} = {H}^{( 1 )} \overbrace{( {a}_{2} + j {I}_{{m}_{0} + 1 , {n}_{0}}^{( 1 )} )}^{{=}^{Δ} {s}_{2}} + {H}^{( 2 )} \overbrace{( {a}_{1} + j {I}_{{m}_{0} + 1 , {n}_{0}}^{( 2 )} )}^{\neq {s}_{1}^{*}} + {η}_{{m}_{0} + 1 , {n}_{0}} \\ = {H}^{( 1 )} {s}_{2} + {H}^{( 2 )} ( {s}_{1}^{*} \underbrace{+ j {I}_{2}}_{\to 0} ) + {η}_{{m}_{0} + 1 , {n}_{0}}\end{matrix}\end{matrix}$$

wherein yₘ_{₀}_{,n}_{₀} is the received signal at the resource at (m₀,n₀) in the time-frequency domain, ηₘ_{₀}_{,n}_{₀} is AWGN and Iₘ_{₀}_{,n}_{₀}⁽¹⁾ and Iₘ_{₀}_{,n}_{₀}⁽²⁾ being the intrinsic interference from the first and the second antenna at resource (m₀,n₀) respectively, wherein precoding symbols in the second embodiment are chosen to cancel out the composite intrinsic interference, which relates to the combination of two intrinsic interferences and is defined as

I₁≙Iₘ_{₀}_{+1,n}_{₀}⁽¹⁾−Iₘ_{₀}_{,n}_{₀}⁽²⁾

I₂≙Iₘ_{₀}_{,n}_{₀}⁽¹⁾+Iₘ_{₀}_{+1,n}_{₀}⁽²⁾

Wherein the precoding symbols are selected so that the composite interference I₁ and I₂ is cancelled to thereby obtain an orthogonal design by forcing interference I₁ and I₂ to zero by the precoding symbols.

In this manner an orthogonal design can be achieved.

According to one embodiment when considering the ambiguity functions that reflect the interference from neighbouring transmission resources the the receive signals for the subcarriers m₀ and m₀+1 read as

yₘ_{₀}_{,n}_{₀}=H⁽¹⁾(s₁^{R}+j(w₁x₁+Iₘ_{₀}_{,n}_{₀}^{(1)″}))−H⁽²⁾(s₂^{R})−j(w₁x₂+Iₘ_{₀}_{,n}_{₀}^{(2)″}))+ηₘ_{₀}_{,n}_{₀}

yₘ_{₀}_{+1,n}_{₀}=H⁽¹⁾(s₂^{R}−j(w₃x₁+Iₘ_{₀}_{+1,n}_{₀}^{(1)″}))+H⁽²⁾(s₁^{R}+j(w₃x₂−Iₘ_{₀}_{+1,n}_{₀}^{(2)″}))+ηₘ_{₀}_{+1,n}_{₀}

and wherein the precoding signals constraints are determined based on the constraints that for the composite Interference I₁=I₂=0, which can be written as

$$[ \begin{matrix}{w}_{1} & - {w}_{1} \\ {w}_{3} & {w}_{3}\end{matrix} ] [ \begin{matrix}{x}_{1} \\ {x}_{2}\end{matrix} ] = [ \begin{matrix}{I}_{{m}_{0} , {n}_{0}}^{( 1 )} - {I}_{{m}_{0} , {n}_{0}}^{( 2 )} \\ {I}_{{m}_{0} + 1 , {n}_{0}}^{( 1 )} + {I}_{{m}_{0} + 1 , {n}_{0}}^{( 2 )}\end{matrix} ]$$

And the desired desired precoding symbols x₁ and x₂ are determined by solving this equation system.

In this manner the precoding symbols can be determined, and two precoding symbols only are necessary to increase the rate to 2/3 while achieving orthogonal design.

In one embodiment, the selecting of the precoding symbol is performed by forcing the intrinsic Interference such that a quasi-orthogonal space-time or space-frequency code is formed.

We denote by quasi-orthogonality that the intrinsic interference at the data containing symbol, when received by the receiver, is forced to a small non-zero value when applying the space-time or space-frequency code. Thereby “small” means a value below a predefined non-zero value, which can be a threshold system parameter, which is configurable.

The further effect of the quasi-orthogonal design is that there can remain a certain intrinsic Interference at the receiver, which, however, may be either small enough that it could be negligible for performance degradation or the receiver may be able to cancel it by an interference cancellation means such as successive interference cancellation. This has advantages that complexity for computing the precoding symbol and/or transmit energy can be reduced because the constraints on the precoding symbol calculation are relaxed.

In one embodiment, the precoding symbol is designed to null the intrinsic interference defined in (6). This can result in the quasi-orthogonal design since there may be certain remaining intrinsic interference when received at the receiver. This is because the intrinsic interference defined in (6) take into account only the immediate neighbour resources.

In one embodiment, the precoding symbol is designed to null the intrinsic interference originating from a subset of resources. In one further embodiment, resources are selected according to the significances determined by the ambiguity functions of the filter used.

This has advantage of taking into account only the resources that cause the most significant intrinsic interferences in an efficient manner. This can result in the quasi-orthogonal design since there may be certain remaining intrinsic interference when received at the receiver.

In one embodiment the selecting of the precoding symbol is performed by forcing the intrinsic interference, when received by a receiver, to be a smaller than a predefined non-zero value. The value may also be one of a predefined set of values which can be a threshold system parameter, which is configurable and may be specified in a standardization specification.

In one embodiment, the offset quadrature amplitude modulation is applied with the filter bank multicarrier FBMC.

This has the effect and advantage that transmit diversity according to the scheme of Alamouti may be applied to a FBMC transmission scheme.

In one embodiment, the data is contained on the real part of the demodulated signal.

In one embodiment, two real-valued pulse amplitude modulation PAM symbols a₁, a₂ are to be transmitted, wherein data containing symbols a₁, a₂ are transmitted using resources (m₀,n₀) and (m₀+u, n₀+v) in the time-frequency domain by the first antenna; and wherein data containing symbols −a₂, a₁, are transmitted using resources (m₀,n₀) and (m₀+u, n₀+v) in the time-frequency domain by the second antenna, wherein u, t are non-zero.

This has the effect and advantage that the quality of the transmission from a transmitter using two antennas to a receiver using one antenna may be improved following a transmit diversity scheme related to the scheme of Alamouti.

In one embodiment, two real-valued pulse amplitude modulation PAM symbols a₁, a₂ are to be transmitted, wherein data containing symbols a₁, a₂ are transmitted using resources (m₀,n₀) and (m₀+u, n₀) in the time-frequency domain by the first antenna, wherein data containing symbols −a₂, a₁, are transmitted using resources (m₀,n₀) and (m₀+u, n₀) in the time-frequency domain by the second antenna, and wherein u is non-zero.

This has the effect and advantage that the quality of the transmission from a transmitter using multiple antennas to a receiver may be improved following a transmit diversity scheme of Alamouti.

In one embodiment, two real-valued pulse amplitude modulation PAM symbols a₁, a₂ are to be transmitted, wherein data containing symbols a₁, a₂ are transmitted using resources (m₀,n₀) and (m₀,n₀+u) in the time-frequency domain by the first antenna; wherein data containing symbols −a₂, a₁, are transmitted using resources (m₀,n₀) and (m₀,n₀+u) in the time-frequency domain by the second antenna, and wherein u is non-zero.

This has the effect and advantage that the quality of the transmission from a transmitter using multiple antennas to a receiver may be improved following a transmit diversity scheme of Alamouti.

According to one embodiment, two precoding symbols are used for the PAM symbols transmitted by the first antenna and two precoding symbols are used for the PAM symbols transmitted by the second antenna, wherein each of the precoding symbols are selected such as to force the intrinsic interference at each resource used to transmit the PAM symbols, when received by a receiver, to be zero.

This has the advantage that a coding rate of 1/2 may be achieved, since in each antenna, for two data symbols to be transmitted, two precoding symbols are transmitted.

According to one embodiment, one precoding symbol is used for each transmitted symbol to cancel out the composite intrinsic interference through transmission of the same PAM symbol by the two antennas, when received by a receiver, to be zero.

This has the advantage that the coding rate may be improved to 2/3, since in each antenna, for two data symbols to be transmitted, only one precoding symbols is to be transmitted.

According to an embodiment, a receiving method for demodulating a signal transmitted by the transmission method according to one of preceding embodiments for transmitting a multicarrier signal provided, wherein the received signal is processed by a linear diversity combining for the space-time or space-frequency code and by taking the real part of the output.

According to an embodiment, there is provided an apparatus for transmitting a multicarrier signal that is adapted to carry out the method according to the embodiments described previously.

The effects and advantages achieved by the apparatus correspond to the effects and advantages of the embodiments of the method which have been described in detail above.

### DESCRIPTION OF THE DRAWINGS

FIG. 1 shows the architecture of an FBMC/OQAM transmission scheme with transmit diversity using two transmit antennas.

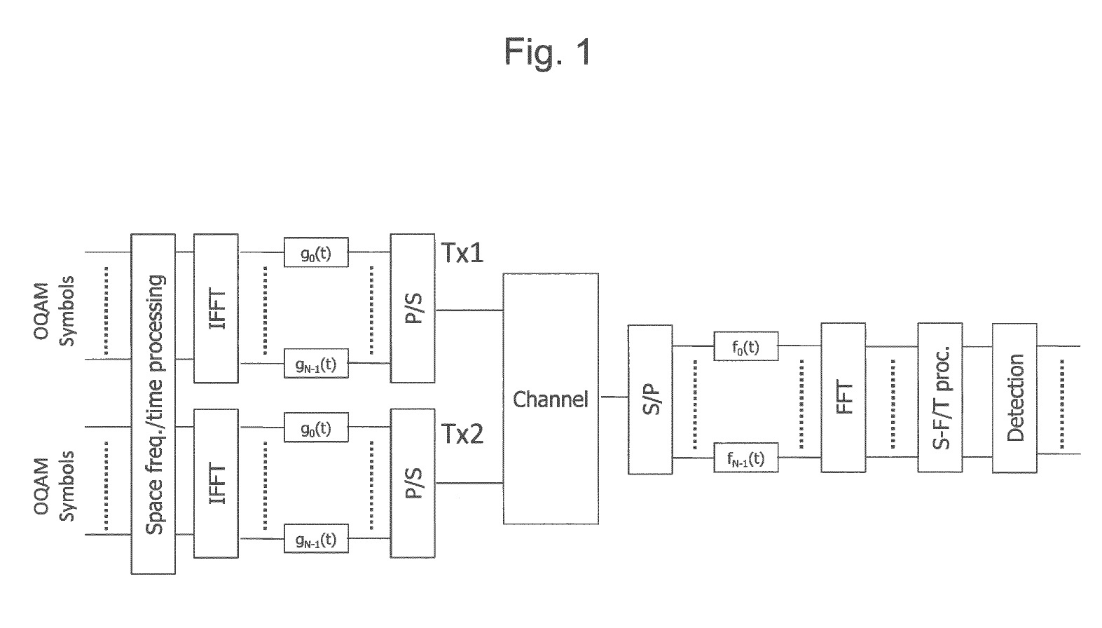

FIG. 2 show an Alamouti scheme for transmit diversity as for example used in LTE.

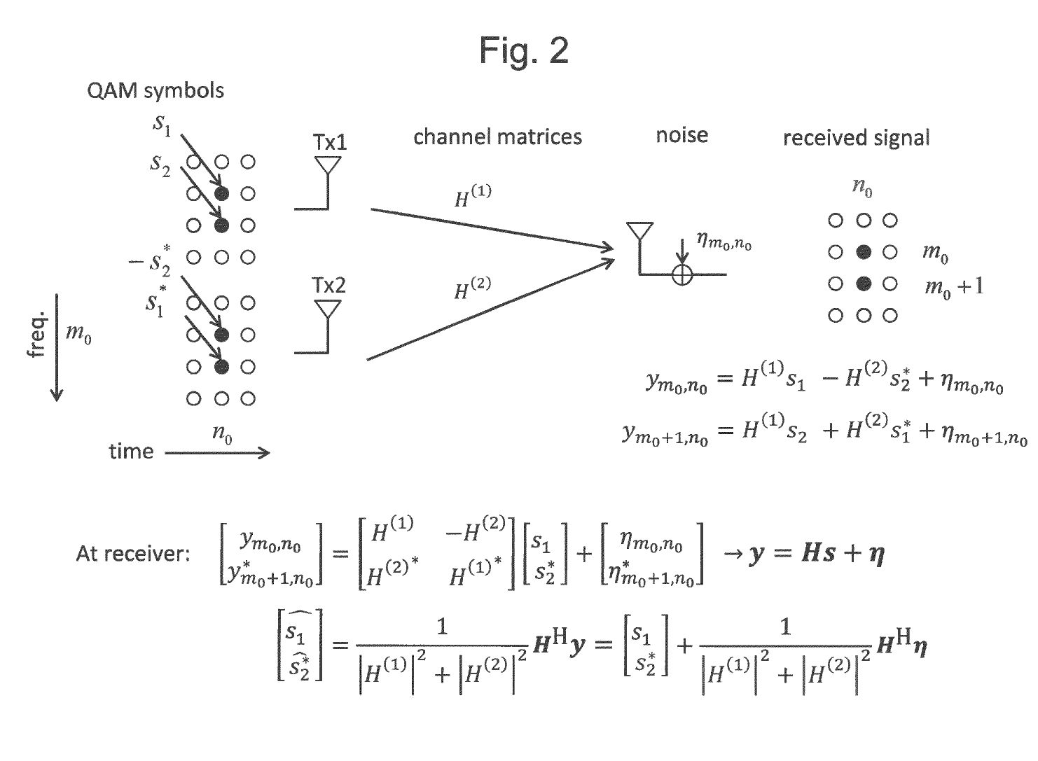

FIG. 3 shows a single input, single output channel model where a PAM signal is transmitted through a single transmit antenna based on FBMC/OQAM.

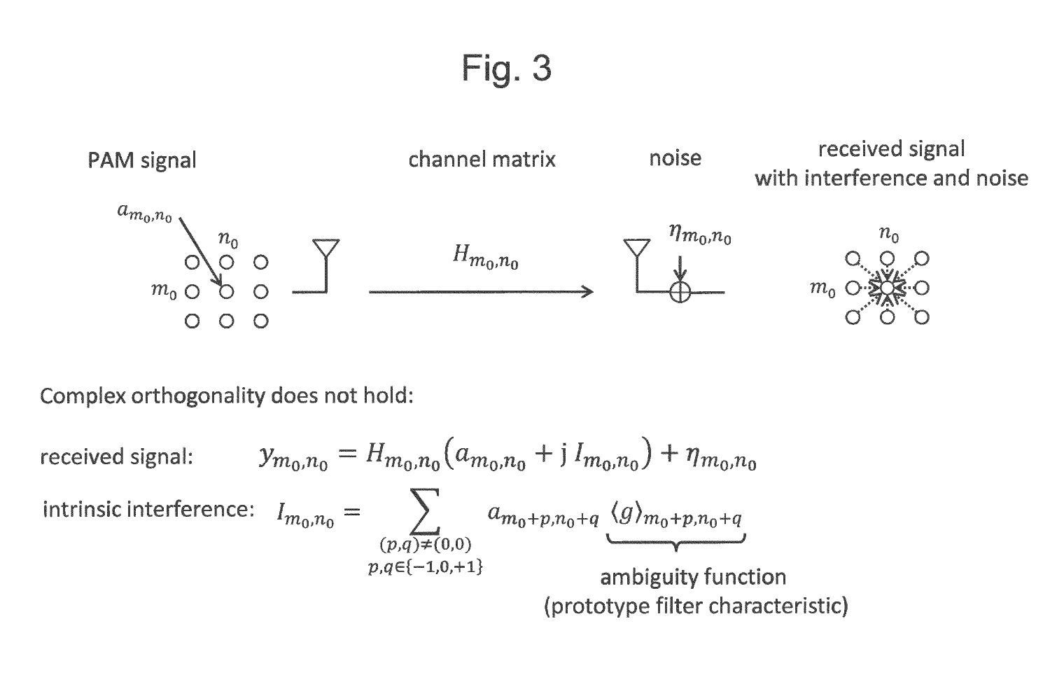

FIG. 4 shows a transmission scheme with two transmit antennas based on FBMC/OQAM where orthogonally is lost through intrinsic interference.

FIG. 5 shows an orthogonal transmission scheme with transmit diversity through two transmit antennas based on FBMC/OQAM where intrinsic interference is cancelled using one precoding symbol per PAM signal.

FIG. 6 shows the principle of transmitting one PAM symbol using two resources.

FIG. 7 shows an orthogonal transmission scheme with transmit diversity through two transmit antennas based on FBMC/OQAM where the “composite” intrinsic interference is cancelled using one precoding symbol for each pair of PAM signals.

### DETAILED DESCRIPTION

At first, some terms used in the description will be defined in the following list of abbreviations.
AWGN Additive White Gaussian Noise
FBMC Filter Bank Multicarrier
LTE Long Term Evolution (mobile phone standard)
OFDM Orthogonal Frequency Division Multiplexing
OQAM Offset Quadrature Amplitude Modulation
PAM Pulse Amplitude Modulation
QAM Quadrature Amplitude Modulation
SISO Single-In-Single-Out

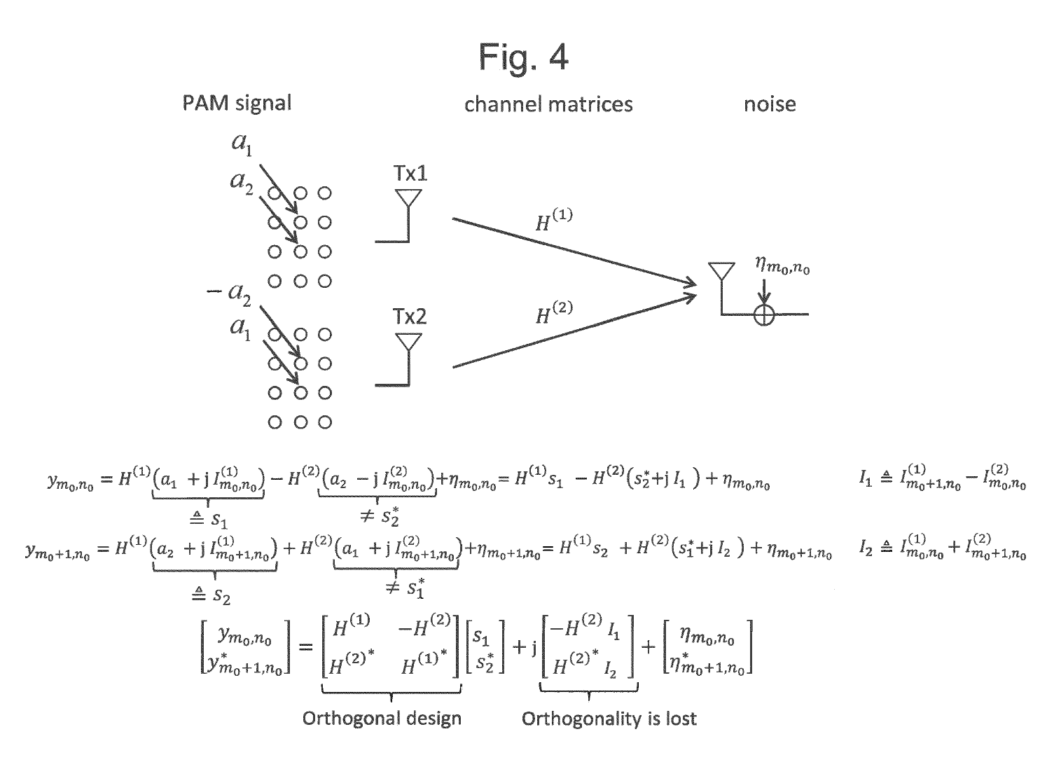

The invention is concerned with filter bank multicarrier (FBMC) offset quadrature amplitude modulation (OQAM) transmission with the so called transmit diversity technique using two transmit antennas as illustrated in FIG. 4.

One objective is to design a transmit diversity scheme from orthogonal design for FBMC/OQAM similar to the above described Alamouti scheme, which Is for example, applied to LTE OFDM system.

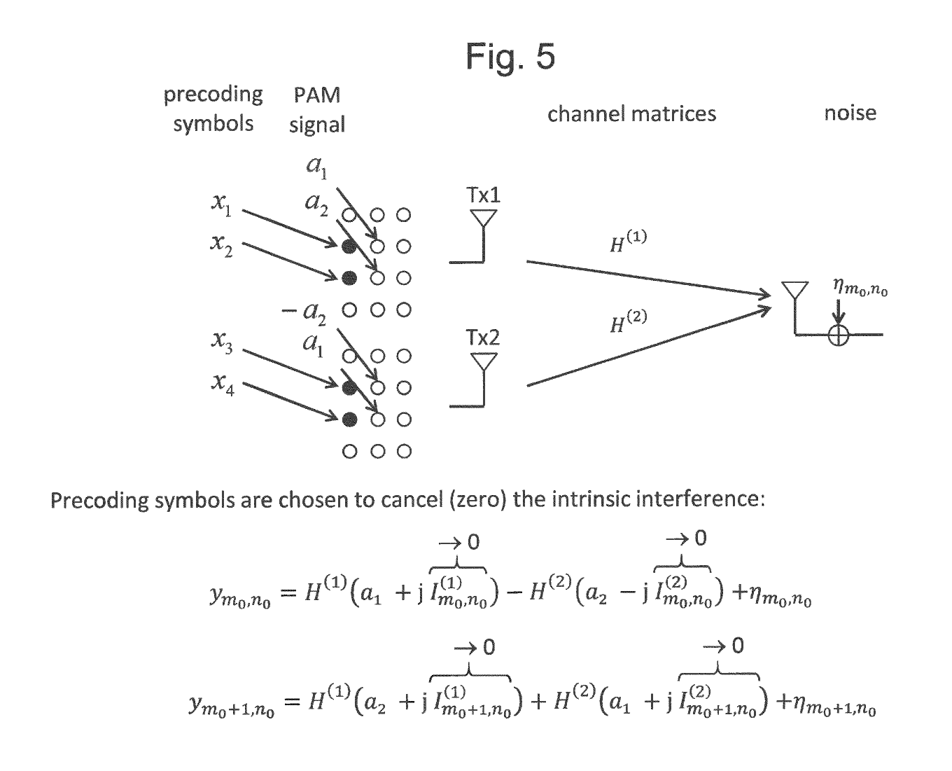

A first embodiment is illustrated in FIG. 5. In this approach orthogonality is achieved in a FBMC/OCAM transmission scheme. In this figure, four precoding symbols are introduced, i.e., two precoding symbols for each transmit antenna.

In the first embodiment, these precoding symbols are chosen such as to cancel the intrinsic Interferences as follows:

$${y}_{{m}_{0} , {n}_{0}} = {H}^{( 1 )} ( {a}_{1} + j \overbrace{{I}_{{m}_{0} , {n}_{0}}^{( 1 )}}^{\to 0} ) - {H}^{( 2 )} ( {a}_{2} - j \overbrace{{I}_{{m}_{0} , {n}_{0}}^{( 2 )}}^{\to 0} ) + {η}_{{m}_{0} , {n}_{0}} \\ {y}_{{m}_{0} + 1 , {n}_{0}} = {H}^{( 1 )} ( {a}_{2} + j \overbrace{{I}_{{m}_{0 + 1} , {n}_{0}}^{( 1 )}}^{\to 0} ) + {H}^{( 2 )} ( {a}_{1} + j \overbrace{{I}_{{m}_{0} + 1 , {n}_{0}}^{( 2 )}}^{\to 0} ) + {η}_{{m}_{0} + 1 , {n}_{0}} \qquad ( 13 )$$

Here, yₘ_{₀}_{,n}_{₀} is the received signal at the resource at (m₀,n₀) In the time-frequency domain, ηₘ_{₀}_{,n}_{₀} is AWGN and Iₘ_{₀}_{,n}_{₀}⁽¹⁾ and Iₘ_{₀}_{,n}_{₀}⁽²⁾ being the intrinsic interference from the first and the second antenna at resource (m₀,n₀) respectively. The precoding symbols x₁,x₂,x₃,x₄ are chosen to cancel (zero) the intrinsic interference individually for each antenna. Specifically, the symbols x₁,x₂ are chosen to cancel the intrinsic interferences Iₘ_{₀}_{,n}_{₀}⁽¹⁾ Iₘ_{₀}_{+1,n}_{₀}⁽¹⁾ of the first antenna and x₃,x₄ are chosen to cancel the intrinsic interferences Iₘ_{₀}_{,n}_{₀}⁽²⁾ Iₘ_{₀}_{+1,n}_{₀}⁽²⁾ of the second antenna.

The first embodiment leads to an orthogonal design and achieves a code rate of 1/2, i.e. the transmission of one data symbol requires two time units since one precoding symbol is transmitted per data symbol.

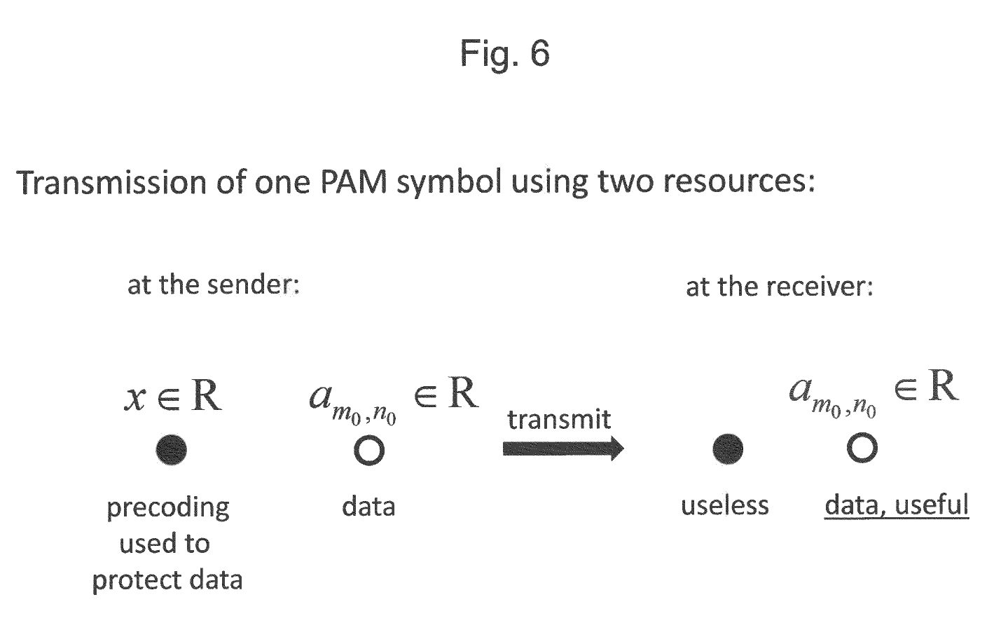

FIG. 6 shows only two transmission resources and only a single antenna is considered for simplicity. In the approaches discussed so far, one of the resources is used for sending the precoding signal that is intended to protect useful data sent using another resource to somewhat “combat” with pure imaginary intrinsic interference observed at the receiver. This means that one real-valued PAM symbol is transmitted using two resources. Hence FIG. 6 illustrates this principle of using a precoding symbol x to “protect” a real-valued data symbol a to be transmitted, wherein the precoding symbol serves to cancel out intrinsic interference and the value received at the resource used for transmission of the precoding symbol is not otherwise used (“useless”) at the receiver side.

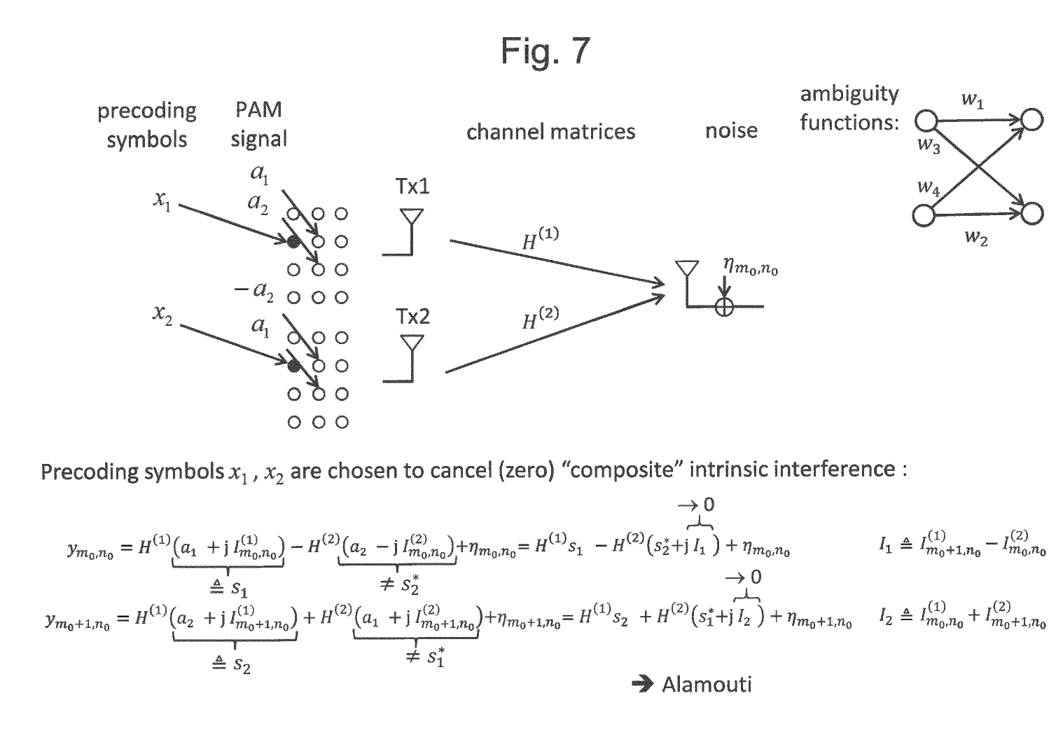

A second embodiment is illustrated in FIG. 7. Compared to the first embodiment described above, the second embodiment improves the coding rate is from 1/2 to 2/3. In the second embodiment, only one precoding symbol is used for each transmit antenna.

The precoding symbols in the second embodiment are chosen to cancel out the so called “composite intrinsic interference”, which can be defined as

I₁≙Iₘ_{₀}_{+1,n}_{₀}⁽¹⁾−Iₘ_{₀}_{,n}_{₀}⁽²⁾ (14)

I₂≙Iₘ_{₀}_{,n}_{₀}⁽¹⁾+Iₘ_{₀}_{+1,n}_{₀}⁽²⁾ (15)

See also the previous attempt to implement the Alamouti scheme, specifically equations (10) and (11). The term “composite” thereby relates to the combination of two intrinsic interferences, wherein each of the two intrinsic interferences is obtained at the receiver at one transmission resource and being caused by neighboring resources of said one transmission resource transmitted by one of two antennas, and wherein each of said two intrinsic interference being caused by the transmission of neighboring resources by one of two antennas.

To illustrate this, the same development of the received signal as in FIG. 4 is used as follows:

$$\begin{matrix}\begin{matrix}{y}_{{m}_{0} , {n}_{0}} = {H}^{( 1 )} \overbrace{( {a}_{1} + j {I}_{{m}_{0} , {n}_{0}}^{( 1 )} )}^{{=}^{Δ} {s}_{1}} - {H}^{( 2 )} \overbrace{( {a}_{2} - j {I}_{{m}_{0} , {n}_{0}}^{( 2 )} )}^{\neq {s}_{2}^{*}} + {η}_{{m}_{0} , {n}_{0}} \\ = {H}^{( 1 )} {s}_{1} - {H}^{( 2 )} ( {s}_{2}^{*} \underbrace{+ j {I}_{1}}_{\to 0} ) + {η}_{{m}_{0} , {n}_{0}}\end{matrix} \\ \begin{matrix}{y}_{{m}_{0} + 1 , {n}_{0}} = {H}^{( 1 )} \overbrace{( {a}_{2} + j {I}_{{m}_{0} + 1 , {n}_{0}}^{( 1 )} )}^{{=}^{Δ} {s}_{2}} + {H}^{( 2 )} \overbrace{( {a}_{1} + j {I}_{{m}_{0} + 1 , {n}_{0}}^{( 2 )} )}^{\neq {s}_{1}^{*}} + {η}_{{m}_{0} + 1 , {n}_{0}} \\ = {H}^{( 1 )} {s}_{2} + {H}^{( 2 )} ( {s}_{1}^{*} \underbrace{+ j {I}_{2}}_{\to 0} ) + {η}_{{m}_{0} + 1 , {n}_{0}}\end{matrix}\end{matrix} \qquad ( 16 )$$

If the precoding symbols are selected so that the composite interference I₁ and I₂ is cancelled, one obtains an orthogonal design and can apply the simple linear processing as the Alamouti scheme for OFDM to obtain

$$= \frac{1}{{\vert {H}^{( 1 )} \vert}^{2} + {\vert {H}^{( 2 )} \vert}^{2}} {H}^{H} y = [ \begin{matrix}{s}_{1} \\ {s}_{2}^{*}\end{matrix} ] + \frac{1}{{\vert {H}^{( 1 )} \vert}^{2} + {\vert {H}^{( 2 )} \vert}^{2}} {H}^{H} η . \qquad ( 17 )$$

It is noted that the outcomes are estimates ŝ₁ and ŝ₂ of the complex valued “virtual symbols” s₁ and s₂ that are real-valued desired signal plus intrinsic interference. Thus, the real-valued desired signals are recovered from the complex estimates as

â₁=Re{ŝ₁} and

â₂=Re{ŝ₂}. (18)

To elaborate in detail further, when applying the precoding symbols x₁ and x₂, and when considering the ambiguity functions shown in FIG. 7 that reflect the interference from neighbouring transmission resources, (16) may be rewritten as:

yₘ_{₀}_{,n}_{₀}=H⁽¹⁾(s₁^{R}+j(w₁x₁+Iₘ_{₀}_{,n}_{₀}^{(1)″}))−H⁽²⁾(s₂^{R}−j(w₁x₂+Iₘ_{₀}_{,n}_{₀}^{(2)″}))+ηₘ_{₀}_{,n}_{₀}

yₘ_{₀}_{+1,n}_{₀}=H⁽¹⁾(s₂^{R}+j(w₃x₁−Iₘ_{₀}_{+1,n}_{₀}^{(1)″}))+H⁽²⁾(s₁^{R}+j(w₃x₂+Iₘ_{₀}_{+1,n}_{₀}^{(2)″}+ηₘ_{₀}_{+1,n}_{₀} (19)

where

Iₘ_{₀}_{,n}_{₀}^{(1)″}=Iₘ_{₀}_{,n}_{₀}⁽¹⁾−w₁x₁

Iₘ_{₀}_{,n}_{₀}^{(2)″}=Iₘ_{₀}_{,n}_{₀}⁽²⁾−w₁x₂

Iₘ_{₀}_{+1,n}_{₀}^{(1)″}=Iₘ_{₀}_{+1,n}_{₀}⁽¹⁾−w₃x₁

Iₘ_{₀}_{+1,n}_{₀}^{(2)″}=Iₘ_{₀}_{+1,n}_{₀}⁽²⁾−w₃x₂ (20)

Then, the receive signals can be further rewritten as

yₘ_{₀}_{,n}_{₀}=H⁽¹⁾s₁−H⁽²⁾(s*₂+jI₁)+ηₘ_{₀}_{,n}_{₀}

yₘ_{₀}_{+1,n}_{₀}=H⁽¹⁾s₂+H⁽²⁾(s*₁+jI₂)+ηₘ_{₀}_{+1,n}_{₀} (21)

where s₁ and s₁ are defined as

s₁=s₁^{R}+j(w₁x₁+Iₘ_{₀}_{,n}_{₀}^{(1)″})

s₂=s₂^{R}+j(w₃x₁+Iₘ_{₀}_{+1,n}_{₀}^{(1)″}) (22)

and also

I₁=Iₘ_{₀}_{+1,n}_{₀}^{(1)″}−Iₘ_{₀}_{,n}_{₀}^{(2)″}=Iₘ_{₀}_{,n}_{₀}⁽¹⁾−Iₘ_{₀}_{,n}_{₀}⁽²⁾−w₁x₁+w₁x₂

I₂=Iₘ_{₀}_{,n}_{₀}^{(1)″}+Iₘ_{₀}_{+1,n}_{₀}^{(2)″}=Iₘ_{₀}_{+1,n}_{₀}⁽¹⁾+Iₘ_{₀}_{+1,n}_{₀}⁽²⁾−w₃x₁−w₃x₂ (23)

The constraints are then I₁=I₂=0, which can be written as

$$[ \begin{matrix}{w}_{1} & - {w}_{1} \\ {w}_{3} & {w}_{3}\end{matrix} ] [ \begin{matrix}{x}_{1} \\ {x}_{2}\end{matrix} ] = [ \begin{matrix}{I}_{{m}_{0} , {n}_{0}}^{( 1 )} - {I}_{{m}_{0} , {n}_{0}}^{( 2 )} \\ {I}_{{m}_{0} + 1 , {n}_{0}}^{( 1 )} + {I}_{{m}_{0} + 1 , {n}_{0}}^{( 2 )}\end{matrix} ] \qquad ( 24 )$$

This equation system can be easily solved to get the desired precoding symbols x₁ and x₂ that satisfy the constraints. And it reduces to the equivalent Alamouti system in (1) and (2). Then, with the additional steps in (17) and (18) the desired signals can be demodulated.

The advantage of the technology according to the embodiments presented herein is the ability to realize transmit diversity from the orthogonal design with full diversity, i.e. diversity order of 2 for two transmit antennas. The embodiments differ e.g. In their effectiveness to exploit available channel resources for the transmission of data symbols (rate loss).

It will be readily apparent to the skilled person that the methods, the elements, units and apparatuses described in connection with embodiments of the invention may be Implemented in hardware, in software, or as a combination of both. In particular it will be appreciated that the embodiments of the invention and the elements of modules described in connection therewith may be implemented by a computer program or computer programs running on a computer or being executed by a microprocessor. Any apparatus implementing the invention may in particular take the form of a computing device acting as a network entity.

1. A method for transmitting a multicarrier signal using a transmit diversity technique with a plurality of transmit antennas (Tx1, Tx2),
wherein said signal is of the offset quadrature amplitude modulation, OQAM, type comprising symbols in the time-frequency space,
wherein the symbols include a data containing symbol (a) and a precoding symbol (x), and
wherein the precoding symbol (x) is selected such that intrinsic interference (I) at the data containing symbol (a), when received by a receiver, is forced to a value which ensures an applied orthogonal space-time or space-frequency code.

2. The method for transmitting of claim 1, wherein said symbols are formed by modulating a real-valued symbol and the intrinsic interference corresponds to the imaginary part of the demodulated signal at said receiver, or
said symbols are formed by modulating an imaginary valued symbol and the intrinsic interference corresponds to the real-valued part of the demodulated signal at said receiver.

3. The method for transmitting of claim 1, wherein the selecting of the precoding symbol is performed by forcing the intrinsic interference, when received by the receiver, to be zero.

4. The method for transmitting according to claim 1, wherein one precoding symbol is used for each transmitted symbol to cancel out the composite intrinsic interference through transmission of the same PAM symbol by the two antennas, when received by a receiver, to be zero.

5. The method for transmitting of claim 1, wherein there are transmitted real-valued PAM symbols a₁ and a₂ are transmitted using the two resources (m₀,n₀) and (m₀+1,n₀) from the transmit antenna Tx1, wherein from transmit antenna Tx2, these PAM symbols a₁ and a₂ are transmitted with and respectively without taking its minus by using the same two resources but now the used resources for a₁ and a₂ are exchanged so that the receive signals for the subcarriers m₀ and m₀+1 read as
$${y}_{{m}_{0} , {n}_{0}} = {H}^{( 1 )} ( {a}_{1} + j \overbrace{{I}_{{m}_{0} , {n}_{0}}^{( 1 )}}^{\to 0} ) - {H}^{( 2 )} ( {a}_{2} - j \overbrace{{I}_{{m}_{0} , {n}_{0}}^{( 2 )}}^{\to 0} ) + {η}_{{m}_{0} , {n}_{0}} \\ {y}_{{m}_{0} + 1 , {n}_{0}} = {H}^{( 1 )} ( {a}_{2} + j \overbrace{{I}_{{m}_{0 + 1} , {n}_{0}}^{( 1 )}}^{\to 0} ) + {H}^{( 2 )} ( {a}_{1} + j \overbrace{{I}_{{m}_{0} + 1 , {n}_{0}}^{( 2 )}}^{\to 0} ) + {η}_{{m}_{0} + 1 , {n}_{0}} \qquad ( 13 )$$
wherein yₘ_{₀}_{,n}_{₀} is the received signal at the resource at (m₀,n₀) in the time-frequency domain, ηₘ_{₀}_{,n}_{₀} is AWGN and Iₘ_{₀}_{,n}_{₀}⁽¹⁾ and Iₘ_{₀}_{,n}_{₀}⁽²⁾ being the intrinsic interference from the first and the second antenna at resource (m₀,n₀) respectively, and wherein precoding symbols x₁,x₂,x₃,x₄ are chosen to cancel (zero) the intrinsic interference individually for each antenna by the symbols x₁,x₂ being chosen to cancel the intrinsic interferences Iₘ_{₀}_{,n}_{₀}⁽¹⁾ Iₘ_{₀}_{+1,n}_{₀}⁽¹⁾ of the first antenna and by x₃,x₄ being chosen to cancel the intrinsic interferences Iₘ_{₀}_{,n}_{₀}⁽²⁾ Iₘ_{₀}_{+1,n}_{₀}⁽²⁾ of the second antenna.

6. The method for transmitting according to claim 1, wherein the selecting of the precoding symbol is performed by forcing the intrinsic interference, when received by a receiver, to be a smaller than a predefined non-zero value.

7. The method for transmitting of claim 1, wherein there are transmitted real-valued PAM symbols a₁ and a₂ are transmitted using the two resources (m₀,n₀) and (m₀+1,n₀) from the transmit antenna Tx1, wherein from transmit antenna Tx2, these PAM symbols a₁ and a₂ are transmitted with and respectively without taking its minus by using the same two resources but now the used resources for a₁ and a₂ are exchanged so that the receive signals for the subcarriers m₀ and m₀+1 read as
$$\begin{matrix}\begin{matrix}{y}_{{m}_{0} , {n}_{0}} = {H}^{( 1 )} \overbrace{( {a}_{1} + j {I}_{{m}_{0} , {n}_{0}}^{( 1 )} )}^{{=}^{Δ} {s}_{1}} - {H}^{( 2 )} \overbrace{( {a}_{2} - j {I}_{{m}_{0} , {n}_{0}}^{( 2 )} )}^{\neq {s}_{2}^{*}} + {η}_{{m}_{0} , {n}_{0}} \\ = {H}^{( 1 )} {s}_{1} - {H}^{( 2 )} ( {s}_{2}^{*} \underbrace{+ j {I}_{1}}_{\to 0} ) + {η}_{{m}_{0} , {n}_{0}}\end{matrix} \\ \begin{matrix}{y}_{{m}_{0} + 1 , {n}_{0}} = {H}^{( 1 )} \overbrace{( {a}_{2} + j {I}_{{m}_{0} + 1 , {n}_{0}}^{( 1 )} )}^{{=}^{Δ} {s}_{2}} + {H}^{( 2 )} \overbrace{( {a}_{1} + j {I}_{{m}_{0} + 1 , {n}_{0}}^{( 2 )} )}^{\neq {s}_{1}^{*}} + {η}_{{m}_{0} + 1 , {n}_{0}} \\ = {H}^{( 1 )} {s}_{2} + {H}^{( 2 )} ( {s}_{1}^{*} \underbrace{+ j {I}_{2}}_{\to 0} ) + {η}_{{m}_{0} + 1 , {n}_{0}}\end{matrix}\end{matrix}$$
wherein yₘ_{₀}_{,n}_{₀} is the received signal at the resource at (m₀,n₀) in the time-frequency domain, ηₘ_{₀}_{,n}_{₀} is AWGN and Iₘ_{₀}_{,n}_{₀}⁽¹⁾ and Iₘ_{₀}_{,n}_{₀}⁽²⁾ being the intrinsic interference from the first and the second antenna at resource (m₀,n₀) respectively,
wherein precoding symbols in the second embodiment are chosen to cancel out the composite intrinsic interference, which relates to the combination of two intrinsic interferences and is defined as
I₁≙Iₘ_{₀}_{+1,n}_{₀}⁽¹⁾−Iₘ_{₀}_{,n}_{₀}⁽²⁾
I₂≙Iₘ_{₀}_{,n}_{₀}⁽¹⁾+Iₘ_{₀}_{+1,n}_{₀}⁽²⁾
wherein the precoding symbols are selected so that the composite interference I₁ and I₂ is cancelled to thereby obtain an orthogonal design by forcing interference I₁ and I₂ to zero by the precoding symbols.

8. The method for transmitting of claim 7, wherein the real-valued desired signals are recovered from the complex estimates as
â₁=Re{ŝ₁} and
â₂=Re{ŝ₂}.

9. The method for transmitting of claim 6, wherein when considering the ambiguity functions that reflect the interference from neighbouring transmission resources, the receive signals for the subcarriers m₀ and m₀+1 read as
yₘ_{₀}_{,n}_{₀}=H⁽¹⁾(s₁^{R}+j(w₁x₁+Iₘ_{₀}_{,n}_{₀}^{(1)″}))−H⁽²⁾(s₂^{R}−j(w₁x₂+Iₘ_{₀}_{,n}_{₀}^{(2)″}))+ηₘ_{₀}_{,n}_{₀}
yₘ_{₀}_{+1,n}_{₀}=H⁽¹⁾(s₂^{R}+j(w₃x₁+Iₘ_{₀}_{+1,n}_{₀}^{(1)″}))+H⁽²⁾(s₁^{R}+j(w₃x₂+Iₘ_{₀}_{+1,n}_{₀}^{(2)″}))ηₘ_{₀}_{+1,n}_{₀}
and wherein the precoding signals constraints are determined based on the constraints that for the composite interference I₁=I₂=0, which can be written as
$$[ \begin{matrix}{w}_{1} & - {w}_{1} \\ {w}_{3} & {w}_{3}\end{matrix} ] [ \begin{matrix}{x}_{1} \\ {x}_{2}\end{matrix} ] = [ \begin{matrix}{I}_{{m}_{0} , {n}_{0}}^{( 1 )} - {I}_{{m}_{0} , {n}_{0}}^{( 2 )} \\ {I}_{{m}_{0} + 1 , {n}_{0}}^{( 1 )} + {I}_{{m}_{0} + 1 , {n}_{0}}^{( 2 )}\end{matrix} ]$$
and the desired precoding symbols x₁ and x₂ are determined by solving this equation system.

10. The method for transmitting of claim 1, wherein said offset quadrature amplitude modulation is applied with the filterbank multicarrier FBMC.

11. The method for transmitting according to claim 1 wherein data is contained on the real part of the demodulated signal.

12. The method for transmitting of claim 1,
wherein two real-valued pulse amplitude modulation PAM symbols a1, a2 are to be transmitted,
wherein data containing symbols a1, a2 are transmitted using resources (m₀,n₀) and (m₀+u,n₀+v) in the time-frequency domain by the first antenna;
wherein data containing symbols −a2, a1, are transmitted using resources (m₀,n₀) and (m₀+u,n₀+v) in the time-frequency domain by the second antenna; and
wherein u, v are non-zero.

13. The method for transmitting of claim 1,
wherein two real-valued pulse amplitude modulation PAM symbols a1, a2 are to be transmitted,
wherein data containing symbols a1, a2 are transmitted using resources (m₀,n₀) and (m₀+u,n₀) in the time-frequency domain by the first antenna;
wherein data containing symbols −a2, a1, are transmitted using resources (m₀,n₀) and (m₀+u,n₀) in the time-frequency domain by the second antenna; and
wherein u is non-zero.

14. The method for transmitting of claim 1,
wherein two real-valued pulse amplitude modulation PAM symbols a1, a2 are to be transmitted,
wherein data containing symbols a1, a2 are transmitted using resources (m₀,n₀) and (m₀,n₀+u) in the time-frequency domain by the first antenna;
wherein data containing symbols −a2, a1, are transmitted using resources (m₀,n₀) and (m₀,n₀+u) in the time-frequency domain by the second antenna; and
wherein u is non-zero.

15. The method for transmitting according to claim 5, wherein two precoding symbols are used for the PAM symbols transmitted by the first antenna and two precoding symbols are used for the PAM symbols transmitted by the second antenna, wherein each of the precoding symbols are selected such as to force the intrinsic interference at each resource used to transmit the PAM symbols, when received by a receiver, to be zero.

16. A receiving method for demodulating a signal transmitted by the transmission method according to claim 1, wherein the received signal is processed by a linear diversity combining for the space-time or space-frequency code and by taking the real part of the output.

17. An apparatus for transmitting a multicarrier signal using a transmit diversity technique with a plurality of transmit antennas (Tx1, Tx2),
wherein the apparatus is adapted to carry out the method for transmitting according to claim 1.
